(19) United States
(12) Patent Application Publication
(10) Pub. No.: US 2012/0115668 A1
(43) Pub. Date: May 10, 2012

(54) DRIVE ARRANGEMENT FOR VEHICLE AUXILIARIES

(75) Inventor: Thomas Justin, Brignais (FR)

(73) Assignee: RENAULT TRUCKS, Saint Priest (FR)

(21) Appl. No.: 13/384,301

(22) PCT Filed: Jul. 22, 2009
(86) PCT No.: PCT/IB2009/007112

§ 371 Date: Jan. 16, 2012

(51) Int. Cl. B60K 25/06; F16H 37/04

(52) U.S. Cl. 475/219; 74/15.82

(57) ABSTRACT

A drive arrangement is provided for at least one auxiliary equipment of a vehicle, wherein the vehicle includes a driveline including a gearbox. The drive arrangement includes a power split device having at least three input/output couplings, the speed of all of the at least three separate couplings being interdependent but not being with a fixed ratio one to the other. A first coupling is connected to the driveline, a second coupling is connected to an electric machine, and a third coupling is connected to the at least one auxiliary equipment. The first coupling is connected to the input shaft of the gearbox.

### BACKGROUND AND SUMMARY

The invention relates to a drive arrangement for vehicle auxiliaries.

A vehicle such as a car or a truck comprises a driveline which includes generally at least one drive engine, which can be an electric motor or a thermal engine, for driving driven wheels of the vehicle. In most cases, the drive engine is connected to the driven wheels through a gearbox having at least one input shaft connected to a drive engine and one output shaft connected to driven wheels of the vehicle.

The vehicle also comprises auxiliaries. A first category of auxiliaries may be formed by those which are directly linked to the functioning of the drive engine, such as, in the case of a thermal engine, the fuel pump, the oil pump, the fan and the generator. A second category may be formed by those which may be necessary for other main functions of the vehicle, such as a power steering pump, an air compressor for an air brake system or an air suspension system. A third category may be formed by those auxiliaries which are not directly linked to the functioning of the vehicle as a means of locomotion, but which may nevertheless be important. For example, these auxiliaries may include the compressor of an air conditioning unit, or, particularly in the case of a commercial vehicle, so called “body-builder” accessories for powering “body-builder equipment”. “Body-builder equipment” usually comprise a piece of equipment which is carried, permanently or not, by the vehicle and may include a trash compactor, a cargo refrigerating unit, a dump body, a crane, a ladder, etc . . . . Such equipment needs a substantial amount of power to be operated and in most cases comprise a dedicated hydraulic pump or a dedicated electric generator which nevertheless need to be powered by the driveline of the vehicle. Such dedicated electric generator or pump may be integrated in the vehicle, or the vehicle may simply comprise a power-take off (PTO) for mechanically driving such kind of demanding equipment. Such a PTO may also be used to drive a piece of equipment which is not carried by the vehicle.

Depending on the auxiliary concerned, it may be required to operate only when the vehicle is running or only when the vehicle is at standstill or both. When the vehicle is at standstill, the auxiliary may be operated either by keeping the drive engine running, in which case the drive engine needs of course to be decoupled from the driven wheels, or by taking energy from an energy accumulator, such as an electric battery, a hydraulic accumulator, etc.

In document U.S. Pat. No. 7,311,627 is shown a drive arrangement for the drive of attached implements for a vehicle such as an agricultural tractor, wherein the drive arrangement comprises a power split device having at least three input/output couplings, the speed of all said at least three separate couplings being interdependent but not being with a fixed ratio one to the other, such as a planetary gear train, and wherein:

a first coupling is connected to the driveline,

a second coupling is connected to an electric machine, and

a third coupling is connected to a PTO.

Thanks to this arrangement, which forms a continuously variable transmission between the driveline and the PTO, it is possible to vary the speed of the PTO and the torque supplied to it substantially independently of the speed of the driveline, simply by controlling the torque and/or the speed of the electric machine on the second coupling. This allows to operate an auxiliary equipment at its optimum speed/torque, substantially independently of the speed/torque of the driveline. In U.S. Pat. No. 7,311,627, it appears that the first coupling is coupled to the driven wheels of the vehicle as the aim of the system is to have the speed of the driven wheels as a reference, the electric motor being used to compensate for the difference between the driven wheels speed and the actual vehicle speed. Such a difference may occur when the driven wheels are skidding. In U.S. Pat. No. 7,311,627, is also disclosed a second electrical machine, which is connected to the first coupling of the power split device, and which may be used as a generator when the first machine is used as a motor. With the drive arrangement as shown in this document, it appears that the PTO cannot be provided with any speed/torque when the vehicle is at standstill.

It is desirable to provide an improved auxiliaries drive arrangement which allows that at least one auxiliary equipment is provided with the adequate speed and/or torque whatever the operating state of the vehicle.

An aspect of the invention provides a drive arrangement for at least one auxiliary equipment of a vehicle, wherein the vehicle comprises a driveline including a gearbox having at least one input shaft connected to a drive engine and one output shaft connected to driven wheels of the vehicle, wherein the drive arrangement comprises a power split device having at least three input/output couplings, the speed of all said at least three separate couplings being interdependent but not being with a fixed ratio one to the other, and wherein:
a first coupling is connected to the driveline,
a second coupling is connected to an electric machine, and
a third coupling is connected to said at least one auxiliary equipment,

characterized in that:
the first coupling is connected to the input shaft of the gearbox.

### DESCRIPTION OF FIGURES

FIGS. 1 to 5 are schematic representations of the main components of a vehicle driveline equipped with an auxiliaries drive arrangement according to five exemplary embodiments of the invention.

### DETAILED DESCRIPTION

On each figure is represented a vehicle driveline 10 which comprises a main drive engine 12, such as an internal combustion engine, a gearbox 14, and a propulsion shaft 16 which is to be connected to non-shown driven wheels of the vehicle, for example through a non-shown differential. A drive engine output shaft 18 is drivingly connected to an input shaft 20 of the gearbox 14 through a clutch 22.

In the examples shown, the gearbox 14 is a manual gearbox which could be automated or not. Said manual gearbox has an output shaft 24 which is aligned with the input shaft 20 and an intermediate shaft 26 which is set in parallel to both the input 20 and the output 24 shafts. The intermediate shaft 26 and the input shaft 20 are drivingly connected through a set of respective gears 28, 30. In this example, the input and intermediate shafts have a fixed speed ratio. In certain gearboxes equipped with a splitter mechanism, not shown, the two shafts 26, 20 are connectable through two sets of meshed gears, but only one set can be active at a time. With a splitter device, the input and intermediate shafts have two speed ratios. With or without the splitter device, it can be considered that the intermediate shaft 26 is permanently connected to the gearbox input shaft 20. The intermediate shaft 26 is also drivingly connectable to the output shaft 24 though a several sets of respective gear wheels 32A, 34A to 32E, 34E. In the shown embodiment, each of the gear wheels 32A, 32B, 32C, 32D, 32E, is freely rotatable on the output shaft but may be selectively drivingly connected to said output shaft 24 through a respective synchronizing and engaging device. The engaged set of gears determines the speed ratio between the intermediate and output shafts, the gearbox being thus a stepped gearbox as opposed to a continuously variable transmission. Gear wheels 32F and 34F are not directly meshed but are both meshed with a reversing wheel 36 to form a reversing set which, when engaged, causes a reverse drive of the vehicle.

The invention is of course not limited to such type of gearbox and could be applied to any type of gearbox having an input shaft drivingly connected or connectable to the drive engine and an output shaft drivingly connected or connectable to the driven wheels of the vehicle. For example, the gearbox could have its output shaft parallel to its input shaft, with or without an intermediate shaft. It could also have a range gear on its output shaft for multiplying the number of overall available speed ratios. It could also have the freewheeling and engageable gear wheels mounted on the intermediate shaft, instead of on the output shaft. It is to be noted that the gearbox 14 and the clutch 22 could be replaced by a so-called “dual-clutch” transmission or by a conventional automatic gearbox with a torque converter.

In all cases, the gearbox has a neutral state where the input and output shafts are disconnected, and a speed engaged state where the input shaft and output shaft are drivingly connected according to a speed ratio which depends on which gear is engaged.

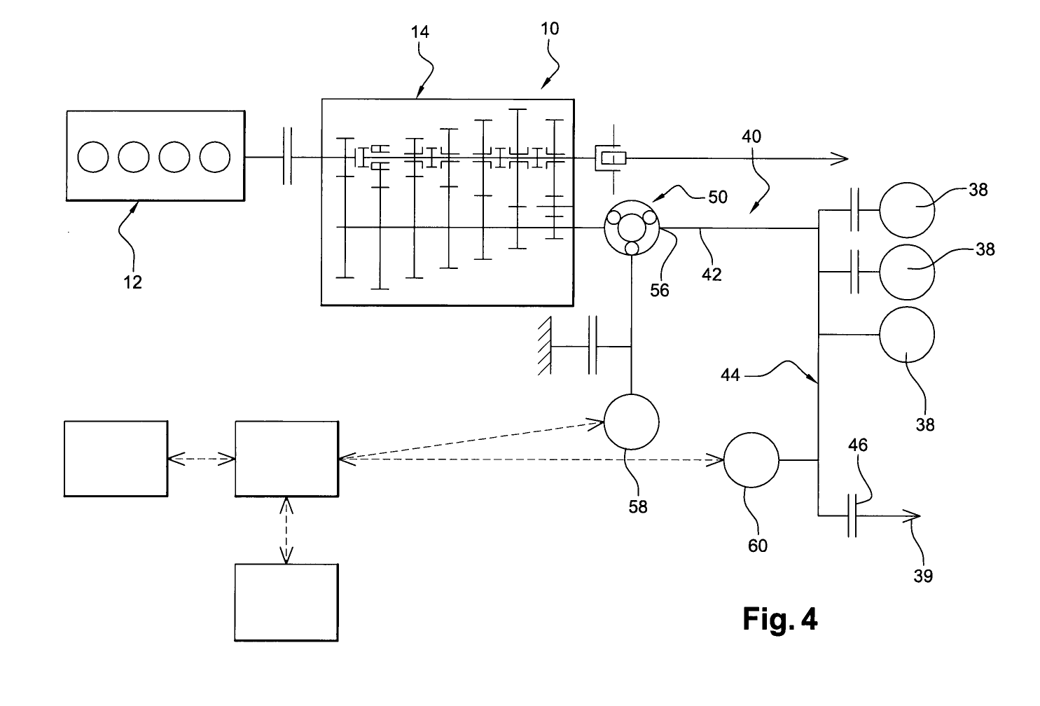

Also shown on the figures is a set of auxiliaries 38 which are to be driven by the driveline through a drive arrangement 40 according to the invention. The auxiliaries 38 can be any one of those mentioned in the background section above, including a power take off 39 such as shown on FIG. 4. Nevertheless, in the case where the main drive engine 12 is a thermal engine and not an electrical engine, it would seem preferable that the auxiliaries 38 are confined to one of the second or third categories of auxiliaries as defined in the background section. In the drawings it is represented that the set of auxiliaries 38 comprises several auxiliaries which are driven in parallel from a main driving shaft 42 through a transmission 44. Of course, the set of auxiliaries could comprise only one auxiliary. The transmission 44 could comprise, as non limiting examples, a set of cascading gear wheels or a belt and pulley arrangement. As represented, one or several auxiliaries can be driven through an auxiliary clutch mechanism 46. Also, auxiliaries could be driven in series, with one auxiliary driving another, rather than in parallel.

The set of auxiliaries 38 is driven by a drive arrangement 40 comprising a power split device 50. The power split device comprises at least three input/output couplings 52, 54 56, the speed of all couplings being interdependent but not being with a fixed ratio one to the other.

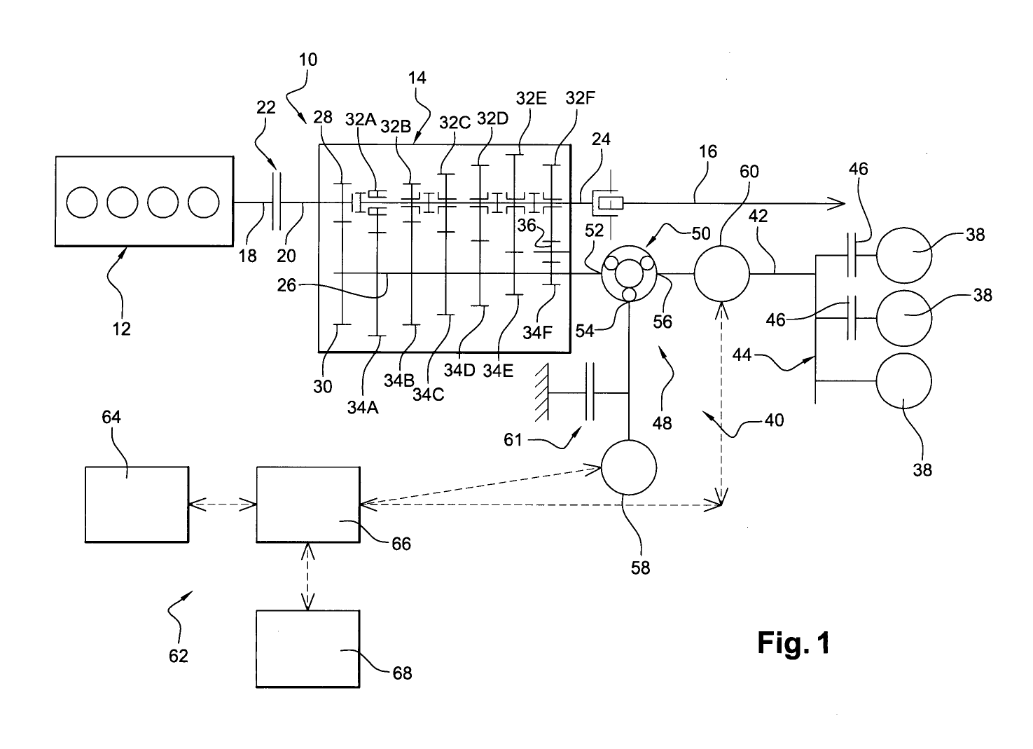

A conventional differential is such a type of device, but, in the examples shown on FIGS. 1 to 4, this device is implemented as a planetary gear 50. Such a gear comprises a sun wheel, a ring wheel coaxial with the sun gear, and a carrier which is coaxial with the sun and ring wheels, where the sun wheel, the ring wheel and the carrier are rotatable one to the other around their common axis, and where said carrier carries rotatable satellite wheels which are meshed with both the sun wheel and the ring wheel. Each of the sun wheel, of the ring wheel and of the satellite carrier can be considered as one input/output of the planetary gear. In such a gear, the speed of the three inputs/outputs are linked one to the other. Basically, the speed of one of the input/outputs is a linear combination of the speeds of the other two input/outputs.

In the above mentioned embodiments of the invention, the first input/output coupling 52 of the three way power split transmission device 50 is mechanically coupled to the driveline 10. The second input/output 54 is mechanically coupled to an electric machine 58, and a third input/output coupling 56 is mechanically coupled to the set of auxiliaries 38. In the shown example, the third coupling 56 is connected to the main driving shaft 42.

Although the couplings 52, 54, 56 may be directly coupled to their corresponding element 10, 58, 38, it could be provided that one or several of the couplings is coupled to the corresponding element through a transmission, such as the transmission 44 through which the third coupling 56 drives the auxiliaries 38 as described above. Particularly, such a transmission can create a speed ratio between the coupling and its corresponding element.

Basically, the drive arrangement thereby allows driving the auxiliaries from a combination of torque and/or speed which can be provided both by the driveline 10, through the first coupling 52, or by the first electric machine 58, through the second coupling 54. In other words, the torque and speed applied by the driveline 10 onto the first coupling 52 is in many cases not controllable, when viewed from the perspective of the auxiliaries 38, because the driveline 10 is mainly controlled by the vehicle user in relation to its propulsion needs and not in view of the needs of the auxiliaries. But, thanks to the drive arrangement 40, it is possible to control the torque applied by the first electric machine 58 to the second coupling 54, said torque being either a driving torque or a braking torque, and said torque being applied in one rotating direction or in the other, in order to deliver on the third coupling 56 a torque and a driving speed which are adequate for the needs of the auxiliaries 38.

The electric machine 58 draws electrical current from an electrical circuit 62 comprising an electric storage system 64, preferably through a power control unit 66, which is preferably electronically controlled, and its control is preferably connected to the electronic architecture of the vehicle, for example through a shared databus. Although the electrical circuit 62 could be a conventional low voltage electrical circuit, generally operating under 24V in the case of heavy duty trucks, the electrical circuit 62 is preferably a high voltage circuit, similar to that of an electric traction circuit of a hybrid electric vehicle. Such a high voltage circuit can of course be connected to the conventional low voltage vehicle electrical network 68, for example through the power control unit 66. The electrical storage system 64 can comprise batteries and/or super capacitors.

According to one aspect of the invention, the first coupling 52 of the power split device is connected to the input shaft of the gearbox. In other words, the drive arrangement 40 is connected to the driveline 10 upstream of the gearbox 14. Such an arrangement proves to be more advantageous than connecting to the driveline downstream of the gearbox, especially in terms of rotation speeds. Indeed, the role of the gearbox 14 is to widen the range of rotating speeds available on its downstream side, compared to the range of rotating speeds available on its upstream side. Upstream and downstream sides of the gearbox 14 are here considered with respect to the flow of power through the driveline when it is in a traditional driving mode. As is well known, the operational range of a heavy diesel engine ranges from less than 800 revolutions per minutes (rpms) at idling, up to 1900 or even 2300 rpms at full speed, with a ratio of around 3 between those extreme operational speeds. Thanks to the gearbox, this can correspond to vehicle speeds ranging from 3 to over 100 km/h, which means that the driven wheels have a speed range exceeding 30. Therefore, being connected to the driveline 10 upstream of the gearbox 14 translates in a more restricted speed range of the first input coupling 52 than if it were coupled to the driveline 10 downstream of the gearbox 14.

In the embodiments shown on the Figures, the first input 52 is not directly connected to the input shaft of the gearbox 14, but to its intermediate shaft 26. This feature, which is of course connected to the specific architecture of the gearbox 14 with such an intermediate shaft, has the advantage that the drive arrangement 40 can be more easily physically located on the output side of the gearbox 14 rather than on its input side, in physical terms. Indeed a typical driveline for a heavy truck typically comprises a drive engine which is longitudinally mounted at the front of the truck, with its output shaft sticking out on a rear side of the engine. The gearbox is generally also longitudinal and immediately stacked on that rear side of the engine, with only the clutch in between. Therefore, the physical input side of the gearbox 14, wherefrom its input shaft sticks out, is frequently directly in contact with the drive engine 12, and is more or less entirely received within the engine compartment, where available space is scarce. In a typical heavy truck driveline, the output side of the gearbox is on the other side of the gearbox compared to the input side, i.e. on the rear side, where there is usually more space available on the truck.

Therefore, connecting the power split device to the intermediate shaft 26 allows, in the case of a typical heavy truck driveline, locating physically the drive arrangement 40 on the output side, with more latitude for installing the drive arrangement, while nevertheless having it connected to the upstream side of the gearbox, with the above mentioned benefit of reduced rotating speed ranges. It can therefore be considered that, when connected to the intermediate shaft 26, the first coupling 52 is connected to the input shaft of the gearbox, although indirectly.

Having the drive arrangement 40 connected to the upstream side of the gearbox 14 also allows having the possibility to drive the auxiliaries 38 at vehicle standstill using the drive engine and not only the electric machine 58. Indeed, the gearbox 14 has a neutral state where the input and output shafts are disconnected. Therefore, when the vehicle is standing still, the output shaft 24 of the gearbox being also at a standstill, it is possible to set the gearbox in the neutral state and to have the clutch 22 engaged so that the input shaft of the gearbox is driven by the drive engine, thereby providing torque to the drive arrangement 40. A similar operation is possible with an automatic gearbox which has a neutral state: it is then interesting to have the drive arrangement connected to the input shaft of the gearbox which can then be driven through the torque converter. In such a case, the torque converter will preferably be locked, to limit losses.

It has been seen previously that the vehicle driveline 10 comprises at least one clutch 22 between the engine and the input shaft of the gearbox. Thanks to such a clutch, it is possible to provide that the first coupling 52 of the power split device 50 is coupled or not to the drive engine depending on the state of the clutch 22, simply by engaging or disengaging the clutch. When the clutch is disengaged, it is possible to provide torque to the first coupling of the power split device, and thereby to the auxiliaries 38, even when the drive engine is shut down. Indeed, with the clutch 22 disengaged, the input shaft of the gearbox can rotate freely. In one scenario, the vehicle is moving forward with its drive engine shut down. In such a case, with the clutch disengaged and the gearbox in a gear-engaged state, the driven wheels of the vehicle are able to drive the input and/or intermediate shaft of the gearbox, thereby providing torque to the drive arrangement 40 and ultimately driving the auxiliaries. Such a scenario can be implemented when the vehicle is decelerating, or when it is freewheeling down a hill. Indeed, engine shut-down is not normally performed in such cases with a conventional truck because this would shut down many accessories which are necessary for the safe driving of the vehicle, such as the steering assistance or the air brakes compressor. Thanks to the invention, such accessories can be driven even when the drive engine is shut-down, which makes the shut-down of the engine possible in more instances of the vehicle's operations, without compromising safety. Engine shut-down in such cases increases fuel economy.

According to another aspect of the shown embodiments, the drive arrangement 40 comprises a second electrical machine 60 which is coupled to the third coupling 56, together with the set of auxiliaries 38. Such second electric machine 60 can be mounted directly on the third coupling 56 or on the main driving shaft 42, as shown on FIG. 1, or can be mounted in parallel on the transmission 44, as represented on FIG. 4, to drive the auxiliaries 38. In any case, the second electrical machine is considered as connected to the third coupling 56 as long as there is a fixed ratio of speed between the two. The second electrical machine 60 can be connected to the same electrical network 62 as the first, for example through the same power control unit 66 or through another power control unit. The second electrical machine is used either as a motor or a generator. Depending on the operating conditions, the first 58 and second 60 electric machines are used either separately or jointly to achieve the right speed and torque to be fed to the auxiliaries 38. Also, having these two machines can make it possible to operate one as a generator and the other as a motor so that, in order to establish the right torque and speed at the third coupling 56, all or part of the electrical energy used by the motor is provided by the generator. This allows using the electrical machines to adjust the right torque and speed at the third coupling over a period of time without having to oversize the electrical storage system 64. It can even allow suppressing this electrical storage system, or at least not to make use of it for this function.

Having the second machine 60 connected to the third coupling 56 is particularly interesting in the case where the first coupling 52.is coupled to the intermediate shaft 26 of an automated or non-automated manual gearbox of the type shown on the Figures. Indeed, in such gearboxes, it is preferable that the intermediate shaft 26 is not subject to any significant torque during the course of the gearshifts. Otherwise, rapid wear of the synchronizing and engaging devices could occur. Therefore, if the second machine 60 were connected to the first coupling 52, then it would be necessary to shut down the second machine, but also the first machine 58 during each gearshift, leading to a disruption of the torque supplied to the auxiliaries. To the contrary, having the second machine on the third input allows driving the auxiliaries thanks to the second machine during the gear shifts, without having any torque applied on the first input. During the gear shifts, the first and second couplings can simply be allowed to run freely, with no torque transmission.

In the case of an automatic gearbox, where the drive system 40 would be connected to the input shaft of the gearbox or in the case of twin-clutch transmission, the second electrical machine could also be located on said input shaft of the gearbox, preferably downstream of the torque converter in the former case and upstream of the twin clutches in the latter case.

According to still another aspect of the shown embodiments, the second coupling 54 of the drive arrangement's power split device 50 is equipped with a mechanical locking device for blocking any movement of the second coupling when it is locked. In the shown embodiment, the mechanical locking device comprises a clutch 61, which could be a friction clutch or a dog clutch, having a mobile part connected to the second coupling, for example to the rotor of the first electric machine 58, and a static part connected to a static element of the drive arrangement 40. Locking the second coupling 54 ensures that no power is transmitted to or from the power split device though the second coupling 54. The speed of the second coupling 54 is of course virtually zero, and the power split device is then a simple fixed ratio mechanical transmission device between its first and third input/output couplings 52, 56, having an optimal efficiency because not subject to electric losses. The locking device 61 may be advantageously used each time that auxiliaries are to be driven solely through the input shaft of the gearbox. For example, if the vehicle is at standstill and that the auxiliaries 38 need to be operated over a long period of time at a fixed speed, then it may be preferable not to use the electric machine 56 for adjusting the speed and torque provided to the auxiliaries, but to rather lock the second coupling 54 and to operate the drive engine 12 at the right speed and torque regimes for driving the auxiliaries. Another example where direct mechanical drive of the auxiliaries by the drive engine may be desirable is when the vehicle is cruising on the highway for long distances at its optimum operational speed. Preferably, the power split device will be designed so that the fixed ratio between the first and third inputs of the power split device, when its second coupling 54 is locked, is such that when the auxiliaries are driven at an optimal speed, the engine is also running at an optimal speed in terms of efficiency.

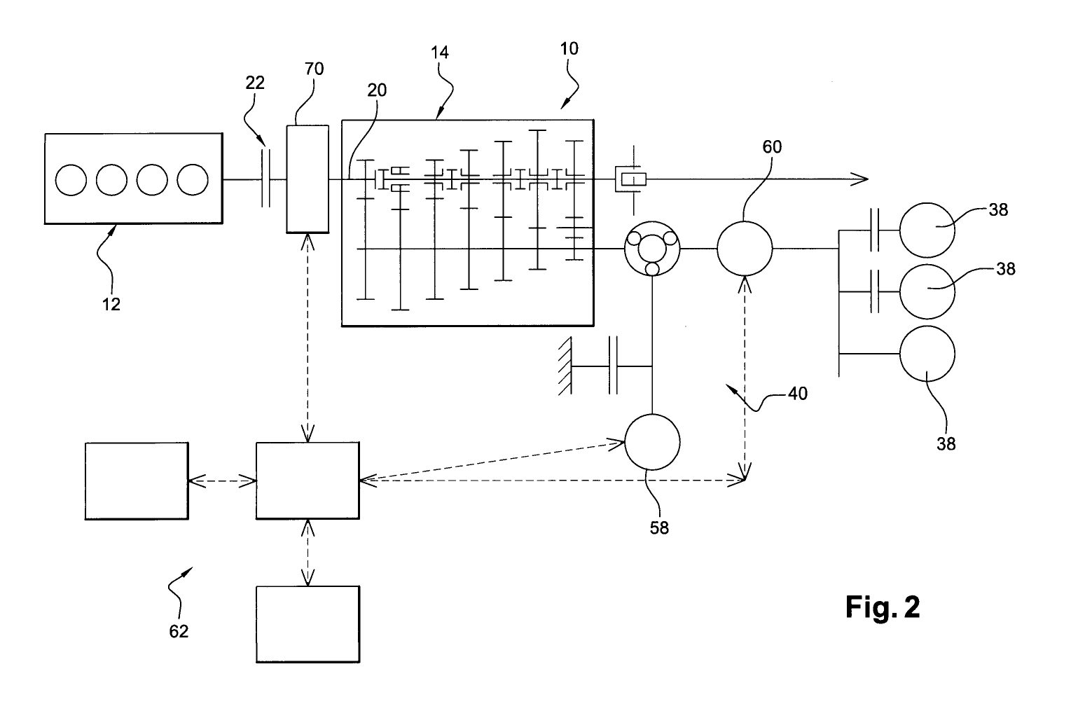

FIG. 2 represents an embodiment of the invention on a parallel hybrid electric driveline. The only difference between the drivelines of FIGS. 1 and 2 is the presence of a traction electric machine 70 between the clutch 22 and the gearbox 14. For example, such a traction machine can have its rotor mounted on the gearbox input shaft 20, or otherwise drivingly connected thereto. The traction machine 70 is connected to the electrical traction network which can be the same network 62 as the one to which the first and second machines 58, 60 are connected to, and it is designed to be able to displace the vehicle.

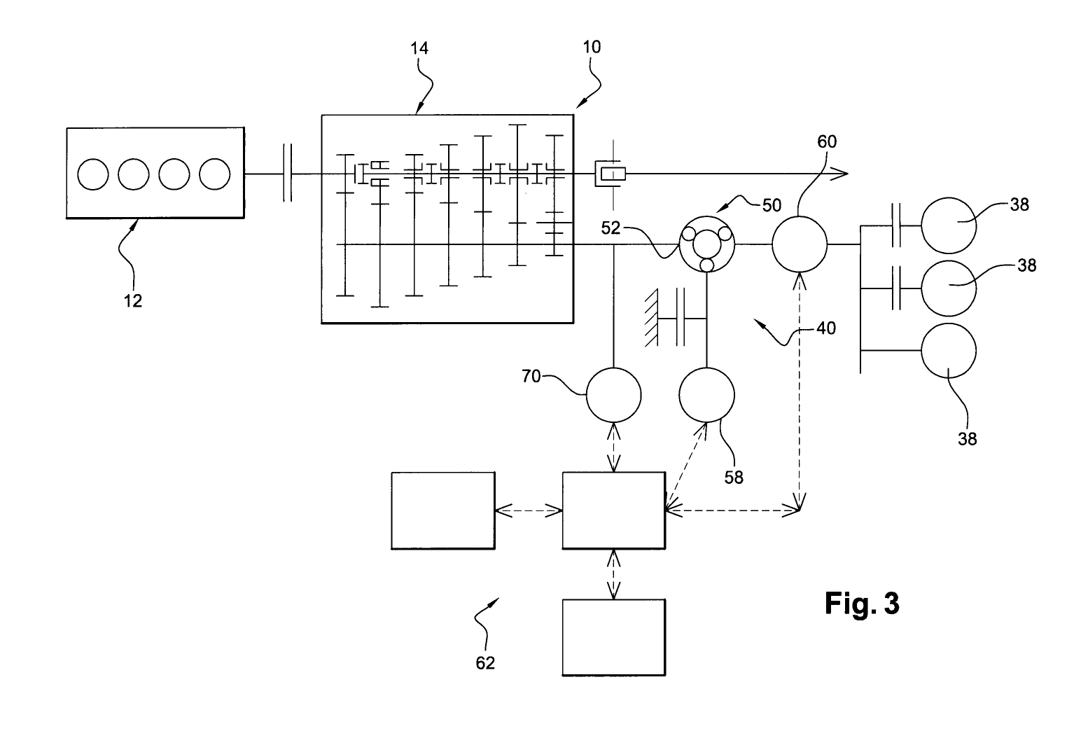

FIG. 3 is a variant of FIG. 2 where the traction electric machine 70 of the hybrid electric driveline is connected to the first coupling 52 of the power split device 50.

Advantageously, the mechanical locking device 61 can be of the normally locked type so that, in case of major electrical or electronic failure, it will lock automatically lock, thereby ensuring that the auxiliaries 38 are driven as long as the input shaft of the gearbox is driven, for example by the drive engine 12 or the electric machine 70, or by the vehicle wheels if the gearbox is not in its neutral state.

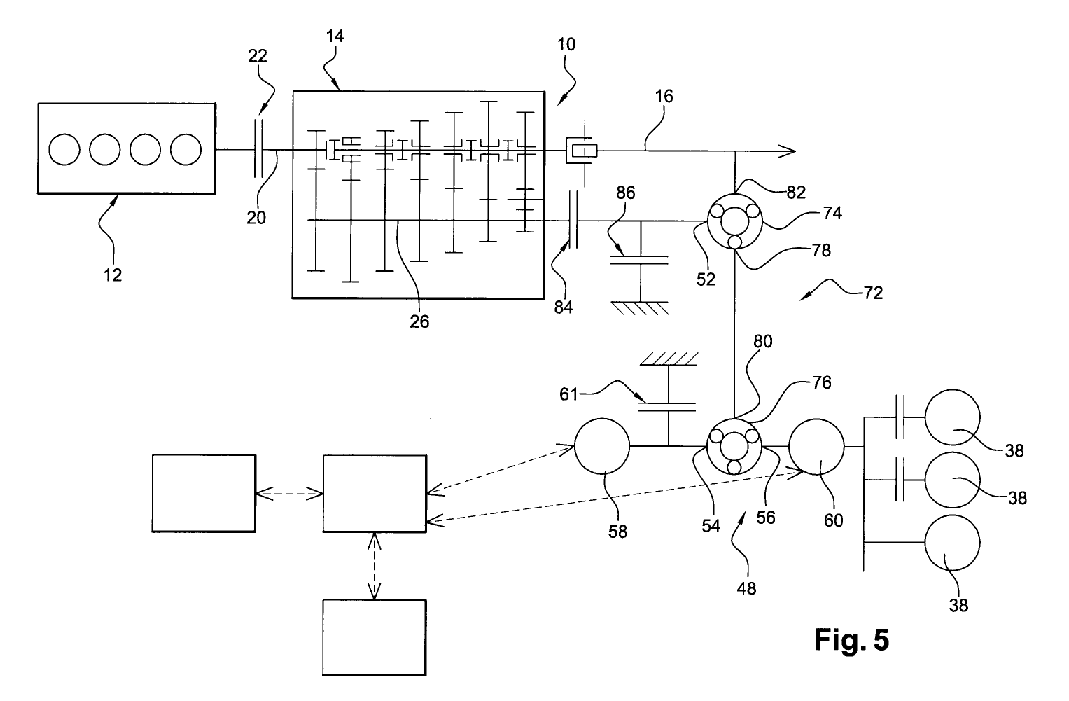

FIG. 5 represents a further refined embodiment of the invention. In this embodiment, the drive arrangement comprises a power split device having four input/output couplings, the speed of all said four separate couplings being interdependent but not being with a fixed ratio one to the other. In fact, as shown on FIG. 5, such a power split device 72 can be embodied as the combination of two planetary gears 74, 76, where a coupling 78 of a first planetary gear 74 is connected to a coupling 80 of the second planetary gear 76, such couplings therefore not being input/output couplings of the combination of gears 72. The power split device has therefore four independent couplings, with, as in the other embodiments;

a first coupling 52 connected to the input shaft 20 of the gearbox, and, more precisely in the shown embodiment, to the intermediate shaft 26 of the gearbox,

a second coupling 54 connected to the first electric machine 58, and which can be equipped with locking means 61,

a third coupling 56 connected to the set of auxiliaries 38, to which a second electric machine 60 can be connected.

The fourth coupling 82 of the power split device 72 is connected to the output shaft of the gearbox, or, which is functionally equivalent, to the propulsion shaft 16 or to the driven wheels. With this arrangement of the power split device 72, it can be seen that the first planetary gear 74 is always able to collect and combine torque and speed from the input shaft and/or from the output shaft 24 of the gearbox 14, as long as at least the drive engine is running or the vehicle is rolling. This combination of torques and speeds is provided to the second planetary gear 76, where it can be combined with the torques and speeds provided by the first and/or second electrical machines for driving the set of auxiliaries 38.

As shown on FIG. 5, a clutch 84 can be provided between the first coupling 52 and the input shaft 20 or intermediate shaft 26 of the gearbox 14, especially for facilitating the gear shifts. Such a clutch could also be implemented in the other embodiments of the invention.

It is also represented on FIG. 5 that the first coupling 52 can be equipped with a locking device 86 for achieving a direct mechanical drive of the auxiliaries 38 by the driven wheels through the power split device 72 when both locking devices 61, 86 on first and second couplings 52, 54 are locked. The locking device 86 blocks any movement of the first coupling when it is locked, and, as locking device 61, it is preferably of the normally locked type. This direct mechanical drive can be especially important in terms of safety if the vehicle, while rolling, suddenly loses power from both the drive engine and from the electrical system. This would allow for example to continue driving a hydraulic power steering pump through the drive arrangement 40 until the vehicle is stopped, thereby helping the driver cope with a dangerous situation.

It is to be noted that the electric machines 58, 60 can be used to produce electricity needed for the vehicle and can even replace the traditional engine-driven generator. Also, the machines can be used as a starter to start the driving engine when the latter is a combustion engine.

Overall, the drive arrangement according to the invention allows a better control of the driving speed of the auxiliaries. As, in many cases, the output of the auxiliaries is directly proportional to the speed at which they are driven, this can lead to a possible optimization of the auxiliaries, which, because they can be driven within an optimum range of speeds, can be made smaller, lighter and/or cheaper.

1. Drive arrangement for at least one auxiliary equipment of a vehicle, wherein the vehicle comprises a driveline including a gearbox having at least one input shaft connected to a drive engine and one output shaft connected to driven wheels of the vehicle, wherein the drive arrangement comprises a power split device having at least three input/output couplings, the speed of all the at least three separate couplings being interdependent but not being with a fixed ratio one to the other, and wherein:
a first coupling is connected to the driveline,
a second coupling is connected to an electric machine, and
a third coupling is connected to the at least one auxiliary equipment,
wherein:
the first coupling is connected to the input shaft of the gearbox and
the power split device comprises a fourth input/output coupling, the speed of all four separate couplings being interdependent but not being with a fixed ratio one to the other, and the fourth coupling is connected to the output shaft of the gearbox.

2. Drive arrangement according to claim 1, wherein the first coupling is connected to the gearbox input shaft through an intermediate shaft of the gearbox which is permanently connected to the gearbox input shaft.

3. Drive arrangement according to claim 1, wherein the first coupling is connected to the gearbox input shaft through a clutch.

4. Drive arrangement according to claim 1, wherein the arrangement further comprises a second electrical machine which is coupled to the third coupling together with the at least one auxiliary equipment.

5. Drive arrangement according to claim 1, wherein the second coupling is equipped with a mechanical locking device.

6. Drive arrangement according to claim 1, wherein a third electric machine is provided which is connected to the first coupling.

7. Drive arrangement according to claim 6, wherein the third electric machine is a drive motor able to displace the vehicle.

8. Drive arrangement according to claim 1, wherein the vehicle driveline comprises at least one clutch between the drive engine and the input shaft of the gearbox, so that the first coupling of the power split device is coupled or not to the drive engine depending on the state of the clutch.

9. Drive arrangement according to claim 1, wherein the gearbox comprises a neutral state in which its input shaft is decoupled from its output shaft, and a gear-engaged stated where the input shaft and the output shaft are drivingly connected.

10. Drive arrangement according to claim 1, wherein the power split device comprises a fourth input/output coupling, the speed of all four separate couplings being interdependent but not being with a fixed ratio one to the other, and in that the fourth coupling is connected to the output shaft of the gearbox.

11. Drive arrangement according to claim 10, wherein the first coupling is equipped with a mechanical locking device.

12. Drive arrangement according to claim 5, wherein the mechanical locking device comprises a clutch having a mobile part connected to the coupling and a static part connected to a static element.

13. Drive arrangement according to claim 5, wherein the mechanical locking device is of the normally locked type.

14. Vehicle, wherein it is equipped with a driveline including a gearbox having at least one input shaft connected to a drive engine and one output shaft connected to driven wheels of the vehicle, and with a drive arrangement according to claim 1 for driving at least one auxiliary equipment of the vehicle.

15. Drive arrangement according to claim, wherein the power split device comprises a combination of two planetary gears, where a coupling of a first planetary gear is connected to a coupling of the second planetary gear, such couplings therefore not being input/output couplings of the combination of gears.
